(19) United States
(12) Patent Application Publication
(10) Pub. No.: US 2007/0004833 A1
(43) Pub. Date: Jan. 4, 2007

(54) METHOD FOR THE PREPARATION OF ARALKYL DIALKYL PHOSPHONATES

(75) Inventor: VAIKUNTH SITARAM PRABHU, MORGANTOWN, WV (US)

Correspondence Address: RANKIN, HILL, PORTER & CLARK, LLP, 925 EUCLID AVENUE, SUITE 700, CLEVELAND, OH, 44115-1405, US

(73) Assignee: FERRO CORPORATION, CLEVELAND, OH (US)

(21) Appl. No.: 11/160,573

(22) Filed: Jun. 29, 2005

(51) Int. Cl. C08K 5/53; C07F 9/06; C07F 9/58

(52) U.S. Cl. 524/126; 558/106; 546/22

(57) ABSTRACT

In accordance with the present invention, an aralkyl halide and a trialkyl phosphite are brought into contact with each other in a reactor at a temperature below about 50° C. to form a reaction mixture. The reaction mixture is then refluxed in the reactor to produce the aralkyl dialkyl phosphonate and an alkyl halide, at least a portion of which can be effectively separated from the aralkyl dialkyl phosphonate during refluxing. The aralkyl dialkyl phosphonate can be recovered as a bottoms product after removal of unreacted reactants and/or unwanted by-products are removed as overhead products via low-pressure distillation. The method allows for the preparation of aralkyl dialkyl phosphonates in high yield, without the need for solvents and/or catalysts and at relatively low reaction temperatures.

### BACKGROUND OF THE INVENTION

1. Field of Invention

The present invention relates to a method for the preparation of aralkyl dialkyl phosphonates.

2. Description of Related Art

Aralkyl dialkyl phosphonates such as, for example, benzyl diethyl phosphonate, are used in a variety of applications including, for example, as intermediates in the preparation of compounds used to treat inflammation and auto-immune diseases, in the preparation of flame retardants, in plant growth regulatory applications, in the preparation of polyesters to control color and provide thermal stability, in petrochemical feedstocks as coking inhibitors, in anti-corrosive applications, in the polymerization of polyethylenes, polypropylenes, EPDM rubbers and in the fabrication of high voltage insulation. Over the years, a variety of techniques have been developed for the preparation of aralkyl dialkyl phosphonates. However, most of these techniques involve complicated or potentially dangerous procedures, the use of expensive or difficult to handle reagents and/or tend to produce the final product at low yield or low purity. Furthermore, some of the techniques are known to produce unwanted by-products, which can contaminate the final product or create disposal hazards.

### BRIEF SUMMARY OF THE INVENTION

The present invention provides a method for the preparation of aralkyl dialkyl phosphonates that overcomes the limitations of the prior art. In accordance with the present invention, an aralkyl halide and a trialkyl phosphite are brought into contact with each other in a reactor at a temperature below about 50° C. to form a reaction mixture. The reaction mixture is then refluxed in the reactor to produce the aralkyl dialkyl phosphonate and an alkyl halide, which can be effectively separated from the aralkyl dialkyl phosphonate either as a gas during refluxing using an amine solution trap or, if the alkyl halide is a liquid, through distillation. The method allows for the preparation of aralkyl dialkyl phosphonates at high yield, without the need for solvents and/or catalysts and at relatively low reaction temperatures.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### DETAILED DESCRIPTION OF THE INVENTION

The present invention provides a method of preparing aralkyl dialkyl phosphonates according to Formula (I) or Formula (II) below: 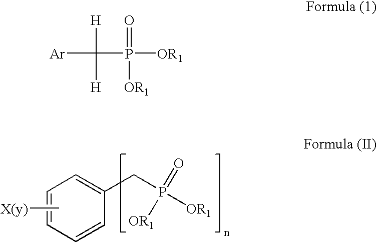
where Ar is: (a) phenyl, 1- or 2-naphthyl, 2-, 3-, or 4-pyridinyl, 1-, 2-, or 9-anthryl, 1-, 2-, 3-, 4-, or 9-phenanthryl, 1-, 2-, or 4-pyrenyl, biphenyl, each of which may optionally be substituted with one or more —[CH₂PO(OR₁)₂] groups; (b) phenyl substituted with 1 through 5 —F; (c) phenyl substituted with 1 through 3 —Cl, —Br, —R₂, or —OR₂; (d) phenyl substituted with —CF₃, —COOH, —COOR₂, —OCOR₂, —SO₂NH₂, —SO₂NR₂, —N(R₂)₂, —NHSO₂R₂, —NHCOOR₂, —CN; or (e) naphthyl substituted with —F, —Cl, —Br, —I, —R₂, —OR₂, —OH, —CF₃, —COOH, —COOR₂, —OCOR₂, —SO₂NH₂, —NHSO₂R₂, or —NHCOR₂; R₁ and R₂ are independently linear or branched alkyl groups containing from 1 to 18 carbon atoms, and R₁ and R₂ can be the same or different; X is any element or functional group capable of replacing one or more ring hydrogen atoms on the aralkyl dialkly phosphonate shown in formula (II); y is a number from 0 to 5; and n is a number from 1 to 6, provided that y+n≦6.

In accordance with the method of the invention, an aralkyl halide according to the formula (III) or (IV) below: 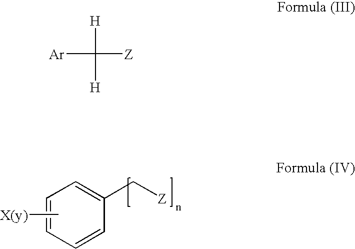
where Z is a halogen and Ar, R₂, X, y and n are the same as Ar, R₂, X, y and n, respectively, in Formula (I) and/or Formula (II), is contacted with a trialkyl phosphite according to Formula (V) below: 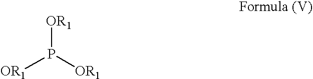
where R₁ is the same as R₁ in Formula (I) and (II), at a temperature below about 50° C. to form a reaction mixture. Most preferably, the aralkyl halide and the trialkyl phosphite are contacted together at ambient temperatures (e.g., ˜22.5° C.) in a reactor vessel equipped with non-oxidizing gas (e.g., N₂ gas) inlet, a mechanical stirrer and a vapor condenser.

The reaction mixture preferably comprises from about 1 to about 1.2 times n moles of the trialkyl phosphite per mole of the aralkyl halide. It will be appreciated that when the aralkyl halide comprises two Z halogens, such as 4-4′ (bis-chloromethyl) diphenyl shown below: 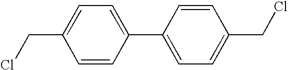
the reaction mixture will comprise from about 1 to about 1.2 times as many moles of the trialkyl phosphite as there are moles of the Z halide in the aralkyl halide (i.e., up to about a 20% mole excess of trialkyl phosphite per mole of the Z halide in the aralkyl halide. More preferably, the mole ratio is from about 1:1 to about 1:1.1 (i.e., up to about a 10% mole excess of the trialkyl phosphite).

The reaction mixture, once formed, is refluxed at a temperature of from about 70° C. to about 250° C. or, more preferably, at a temperature of from about 120° C. to about 200° C. During refluxing, the aralkyl halide reacts with the trialkyl phosphite to form an aralkyl dialkyl phosphonate according to formula (III) or (IV) and an alkyl halide. For example, benzyl chloride and triethyl phosphite can be contacted together in accordance with the method to form benzyl diethyl phosphonate and ethyl chloride, as illustrated below:

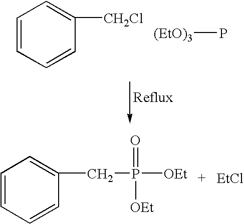

The alkyl halide formed as a reaction product during refluxing typically evolves as a gas, which can be trapped and neutralized by bubbling it through an amine solution such as, for example, an ammonium hydroxide solution. Thus, most of the alkyl halide formed during the reaction can be eliminated as it forms. It will be appreciated that longer alkyl chain trialkyl phosphites produce less volatile alkyl halides, which may not readily evolve as gases during refluxing, and which may have to be separated from the aralkyl dialkyl phosphonate product by other separation techniques (e.g. distillation under reduced pressure).

Refluxing should continue for a period of time sufficient to allow at least about 80 mole percent of the aralkyl halide to react with the trialkyl phosphite. A reflux time of from about 5 hours to about 50 hours is typically adequate.

No solvents or catalysts need be used, and are preferably not used in accordance with the method of the invention. Thus, there are no solvents or catalysts to separate from the final reaction products, and the final reaction products are free of solvent and catalyst contamination issues.

Any unreacted raw materials (e.g., aralkylhalide and trialkyl phosphite) can be removed from the reaction products by distillation as overhead products. The amount of unreacted raw material is typically quite minimal, particularly when a near molar equivalent amount of the aralkyl halide and trialkyl phosphite is used.

After the unreacted raw materials have been removed from the reaction product by distillation, typically at reduced pressure (˜≦200 mm Hg), the aralkyl dialkyl phosphonate product will remain as a bottoms product (i.e., a distillation residue). The final product can be isolated and purified by vacuum distillation as an overhead product, if desired. If the final product is a solid, it can be washed with an appropriate organic solvent such as hexanes or other aliphatic non-reactive solvents, and isolated by filtration. The final product thus obtained is an aralkyl dialkyl phosphonate. The yield from the reaction is typically very high (e.g., above about 90%), at least with respect to convention benzyl dialkyl phosphonate preparation processes.

In U.S. Pat. No. 3,993,852, Mayer et al. disclose that three substituted benzyl dialkyl phosphonate compounds (3-ethyl-benzyl diethyl phosphonate, 3-methoxy-benzyl diethyl phosphonate and 3-chloro-benzyl diethyl phosphonate, respectively) can be manufactured by slowly adding a trialkyl phosphite to a substituted benzyl chloride compound that has been heated to 120° C. and thereafter refluxing the reaction mixture at specified temperatures for specified times (see col. 10, lines 15-62). The final substituted benzyl dialkyl phosphonate compounds are then obtained by vacuum distillation, either as a distillate or as a distillation residue (bottoms product). Mayer et al. teach that the substituted benzyl dialkyl phosphonate compounds can be used to improve the flame resistance of various organic fiber materials when transferred to the organic fiber material from a carrier sheet (see Examples 4 and 5, col. 12, lines 7-62).

In contrast to the teachings of Mayer et al., which disclose adding the trialkly phosphite to a heated aralkyl halide, in the present method of the invention the aralkyl halide and the trialkyl phosphite are contacted together at a temperature below about 50° C. Thus, the present method makes it unnecessary to open a vessel charged with a heated aralkyl halide for the purpose of adding a trialkyl phosphite, which substantially reduces the possibility that aralkyl halide vapor may escape into the workplace or the environment.

The presently most preferred aralkyl halides for use in the invention are benzyl chloride and 4-4′ (bis-chloromethyl) diphenyl. As noted above, the trialkyl phosphite can be a C1-C18 linear or branched trialkyl phosphite, but is more preferably a C1-C12 linear trialkyl phosphite. The presently most preferred trialklyl phosphites for use in the invention are trimethyl phosphite, triethyl phosphite, tripropyl phosphite and tributyl phosphite. Mixtures of two or more trialkyl phosphites can be used to produce a mixture of benzyl dialkyl phosphonates.

Aralkyl dialkyl phosphonates produces in accordance with the method of the invention can be used in a variety of application. The compounds are particularly suitable for use in improving the flame-retardant properties of polymer systems such as polyesters, polyurethanes, polyalkylene terephthalates, polysulfones, polyimides, polyphenylene ethers, styrenic polymers, polycarbonates, acrylic polymers, polyamides, polyacetals, polyvinyl chloride, and polyolefin homopolymers and co-polymers and the like. The aralkyl dialkyl phosphonates produced in accordance with the method of the invention may be added to polymer systems separately, or may be pre-blended with other polymer additives such as, for example, primary phenolic antioxidants, phosphites, phosphonites, hindered amine light stabilizers (HALS), UV absorbers and light stabilizers, thioester synergists, dialkyl stabilizers, tert-amine oxide stabilizers, nitrone stabilizers, nucleating agents, fillers and reinforcing agents, and other additives such as plasticizers, neutralizers (e.g., metal salts of carboxylic acid), epoxidized soyabean oil as described in U.S. Pat. No. 6,103,798.

The following examples are intended only to illustrate the invention and should not be construed as imposing limitations upon the claims.

### EXAMPLE 1

### Preparation of Benzyl Diethyl Phosphonate

A 1-liter 3-neck round bottom flask fitted with N₂ gas inlet, a mechanical stirrer and a water condenser was charged with 189.89 grams (1.5 moles) of benzyl chloride and 249.24 grams (1.5 moles) of triethyl phosphite. The reaction mixture was refluxed at 180-185° C. for 24 hours. Ethyl chloride evolved during refluxing was bubbled through an ammonium hydroxide solution trap. The reaction product was cooled to room temperature (˜22.5° C.) and applied to aspirator pressure and then heated slowly to 100° C. to remove and separate any volatile products, which comprised approximately 1-2 grams. A high vacuum (˜15-20 mm of Hg) was then applied and lower boiling fractions were separated. About 30 grams of an overhead fraction, which contained unreacted triethyl phosphite, benzyl chloride and a small amount of the final product, was collected. Distillation was stopped and final product was cooled to room temperature (˜22.5° C.). The cooled final product was transferred into a glass container. The final product was a colorless liquid. NMR analysis was consistent with the structure of benzyl diethyl phosphonate. The final product weighed 308.9 grams (91% yield).

### EXAMPLE 2

### Preparation of Benzyl Diethyl Phosphonate

A 1-liter 3-neck round bottom flask fitted with N₂ gas inlet, a mechanical stirrer and a water condenser was charged with 50.64 grams (0.4 moles) of benzyl chloride and 66.50 grams (0.4 moles) of triethyl phosphite. The reaction mixture was refluxed at 180-185° C. for 24 hours. Ethyl chloride evolved during refluxing was bubbled through an ammonium hydroxide solution trap. The reaction product was cooled to room temperature (˜22.5° C.) and applied to aspirator pressure and then heated slowly to 100° C. to remove and separate any volatile products, which comprised approximately 1-2 grams. A high vacuum (˜2 mm of Hg) was then applied and lower boiling fractions were separated at a peak distillation temperature of 120° C. Distillation was stopped and the final product was cooled to room temperature (˜22.5° C.). The cooled final product was transferred into a glass container. The final product was a colorless liquid. NMR analysis was consistent with the structure of benzyl diethyl phosphonate. The final product weighed 80.93 grams.

### EXAMPLE 3

### Preparation of Benzyl Dimethyl Phosphonate

A 1-liter 3-neck round bottom flask fitted with N₂ gas inlet, a mechanical stirrer and a water condenser was charged with 189.89 grams (1.5 moles) of benzyl chloride and 186.12 grams (1.5 moles) of trimethyl phosphite. The reaction mixture was refluxed at about 150° C. for 25 hours. Methyl chloride evolved during refluxing was bubbled through an ammonium hydroxide solution trap. The reaction product was cooled to room temperature (˜22.5° C.) and applied to aspirator pressure and then heated slowly to remove and separate any volatile products, which comprised approximately 5.1 grams. A high vacuum (˜15 mm of Hg) was then applied and lower boiling fractions were separated at a peak distillation temperature of about 100° C. Distillation was stopped and final product was cooled to room temperature (˜22.5° C.). The cooled final product was transferred into a glass container. The final product was a colorless liquid. NMR analysis was consistent with the structure of benzyl dimethyl phosphonate. The final product weighed 274.7 grams.

### EXAMPLE 4

### Preparation of 4,4′-(Bis-Methyl Diethyl Phosphonate) Biphenyl

A 250-mL 3-neck round bottom flask fitted with N₂ gas inlet, a mechanical stirrer and a water condenser was charged with 37.68 grams (0.15 mole) of 4,4′ (bis-chloromethyl) biphenyl and 49.85 grams (0.30 moles) of triethyl phosphite. The reaction mixture was refluxed at about 150-160° C. for 24 hours. Ethyl chloride evolved during refluxing was bubbled through an ammonium hydroxide solution trap. The reaction product was cooled to room temperature (˜22.5° C.) and applied to aspirator pressure and then heated slowly to remove and separate any volatile products (very small amounts). A high vacuum (˜15-20 mm of Hg) was then applied and lower boiling overhead fractions were separated and collected. Distillation was stopped and final product was cooled to room temperature (˜22.5° C.). 100 mL of hexanes were added to the final product, which was then filtered using Whatman 54 filter paper and washed with hexanes (2×200 mL). The final product was dried in a vacuum oven at 60° C. for 16 hours. The isolated material weighed 63.3 g, (93% yield), had a melting point of 110-112° C. NMR analysis of the final product was consistent with the known structure of 4,4′-(bis-methyl diethyl phosphonate) biphenyl.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. A method of preparing a benzyl dialkyl phosphonate comprising:
contacting a benzyl halide and a trialkyl phosphite together at a temperature of less than about 50° C. to form a reaction mixture, wherein the ratio of the moles of the benzyl halide to the moles of the trialkyl phosphite in the reaction mixture is from about 1:1 to about 1:1.2;
refluxing the reaction mixture at a temperature of from about 70° C. to about 250° C. for a period of time sufficient to allow at least about 80 mole percent of the benzyl halide to react with the trialkyl phosphite to form a reaction product comprising a benzyl dialkyl phosphonate and an alkyl halide, wherein at least a portion of the alkyl halide is separated from the benzyl dialkyl phosphonate during refluxing; and
distilling the reaction product at a pressure below atmospheric pressure to remove unreacted benzyl halide, unreacted trialkyl phosphite and/or alkly halide as overhead products and yield the benzyl dialkyl phosphonate as a bottoms product.

2. The method according to claim 1 wherein the benzyl halide is benzyl chloride.

3. The method according to claim 1 wherein the alkyl groups on the trialkyl phosphite are linear or branched and have from 1 to 18 carbon atoms.

4. The method according to claim 1 wherein the trialkyl phosphite is selected from the group consisting of trimethyl phosphite, triethyl phosphite, tripropyl phosphite, tributyl phosphite and combinations of the foregoing.

5. The method according to claim 1 wherein the alkyl halide is separated from the benzyl dialkyl phosphonate during refluxing as a gas that is bubbled through an aqueous amine solution.

6. The method according to claim 1 wherein no solvents for the benzyl halide or the trialkyl phosphite are present during refluxing.

7. The method according to claim 1 wherein no catalysts are present during refluxing.

8. The method according to claim 1 wherein the yield of the benzyl dialkyl phosphonate after distillation is greater than 80 mole percent.

9. The method according to claim 1 further comprising adding the benzyl dialkyl phosphonate to a polymer system.

10. The method according to claim 9 wherein the polymer system is selected from the group consisting of polyesters, polyurethanes, polyalkylene terephthalates, polysulfones, polyimides, polyphenylene ethers, styrenic polymers, polycarbonates, acrylic polymers, polyamides, polyacetals, polyvinyl chloride, and polyolefin homopolymers and co-polymers.

11. The method according to claim 10 wherein the benzyl dialkyl phosphonate is blended with one or more additives selected from the group consisting of primary phenolic antioxidants, phosphites, phosphonites, hindered amine light stabilizers (HALS), UV absorbers and light stabilizers, thioester synergists, dialkyl stabilizers, tert-amine oxide stabilizers, nitrone stabilizers, nucleating agents, fillers, reinforcing agents, plasticizers, neutralizers, metal salts of carboxylic acid and epoxidized soyabean oil before the additives are added to the polymer system.

12. A method of preparing a benzyl dialkyl phosphonate comprising:
contacting benzyl chloride and a C1-C12 linear or branched trialkyl phosphite together in the absence of solvents or catalysts at a temperature of less than about 50° C. to form a reaction mixture, wherein the ratio of the moles of the benzyl chloride to the moles of the trialkyl phosphite in the reaction mixture is from about 1:1 to about 1:1.2;
refluxing the reaction mixture at a temperature of from about 120° C. to about 200° C. for a period of time sufficient to allow at least about 80 mole percent of the benzyl chloride to react with the trialkyl phosphite to form a reaction product comprising a benzyl dialkyl phosphonate and an alkyl chloride, wherein at least a portion of the alkyl chloride is separated from the benzyl dialkyl phosphonate during refluxing; and
distilling the reaction product at a pressure of less than about 200 mm Hg to remove unreacted benzyl chloride, unreacted trialkyl phosphite and/or alkyl chloride as overhead products and yield at least about 80 mole percent of the benzyl dialkyl phosphonate as a bottoms product.

13. The method according to claim 12 wherein the trialkyl phosphite is selected from the group consisting of trimethyl phosphite, triethyl phosphite, tripropyl phosphite, tributyl phosphite and combinations of the foregoing.

14. The method according to claim 12 wherein the alkyl chloride is separated from the benzyl dialkyl phosphonate during refluxing as a gas that is bubbled through an amine solution.

15. The method according to claim 12 further comprising adding the benzyl dialkyl phosphonate to a polymer system.

16. The method according to claim 12 wherein the polymer system is selected from the group consisting of polyesters, polyurethanes, polyalkylene terephthalates, polysulfones, polyimides, polyphenylene ethers, styrenic polymers, polycarbonates, acrylic polymers, polyamides, polyacetals, polyvinyl chloride, and polyolefin homopolymers and co-polymers.

17. A method of preparing a aralkyldialkyl phosphonate comprising:
providing an aralkyl halide according to formula (III) or formula (IV): 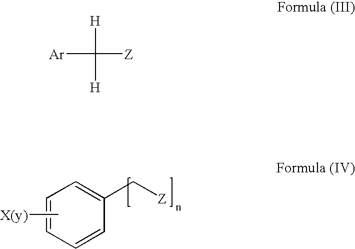
where Ar is: (a) phenyl, 1- or 2-naphthyl, 2-, 3-, or 4-pyridinyl, 1-, 2-, or 9-anthryl, 1-, 2-, 3-, 4-, or 9-phenanthryl, 1-, 2-, or 4-pyrenyl, biphenyl, each of which may optionally be substituted with one or more —[CH₂Z] groups; (b) phenyl substituted with 1 through 5 —F; (c) phenyl substituted with 1 through 3 —Cl, —Br, —R₂, or —OR₂; (d) phenyl substituted with —CF₃, —COOH, —COOR₂, —OCOR₂, —SO₂NH₂, —SO₂NR₂, —N(R₂)₂, —NHSO₂R₂, —NHCOOR₂, —CN; or (e) naphthyl substituted with —F, —Cl, —Br, —I, —R₂, —OR₂, —OH, —CF₃, —COOH, —COOR₂, —OCOR₂, —SO₂NH₂, —NHSO₂R₂, or —NHCOR₂; where R₂ is a linear or branched alkyl group containing from 1 to 18 carbon atoms; Z is a halogen; X is any element or functional group capable of replacing one or more ring hydrogen atoms on the aralkyl halide shown in formula (IV); y is from 0 to 5; and n is from 1 to 6, provided the sum of y+n≦6;
providing a C1-C18 linear or branched trialkyl phosphite according to formula (V): 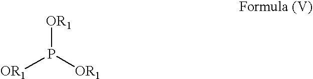
where R₁ is a linear or branched alkyl group containing from 1 to 18 carbon atoms and may be the same as or different than R₂ in Formula (III);
contacting the aralkyl halide and the trialkyl phosphite together in the absence of solvents or catalysts at a temperature of less than about 50° C. to form a reaction mixture, wherein the reaction mixture comprises from about 1 to about 1.2 times n moles of the trialkyl phosphite per mole of the aralkyl halide;
refluxing the reaction mixture at a temperature of from about 70° C. to about 250° C. for a period of time sufficient to allow at least about 80 mole percent of the aralkyl halide to react with the trialkyl phosphite to form a reaction product comprising an aralkyl dialkyl phosphonate and an alkyl halide, wherein at least a portion of the alkyl halide is separated from the aralkyl dialkyl phosphonate during refluxing; and
distilling the reaction product at a pressure of less than about 200 mm Hg to remove unreacted aralkyl halide, unreacted trialkyl phosphite and/or alkly halide as overhead products and yield at least about 80 mole percent of an aralkyl dialkyl phosphonate according to Formula (I) or (II) as a bottoms product: 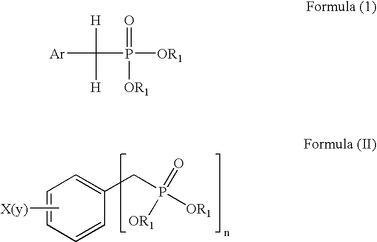
where Ar, R₁, R₂, X, y and n, are the same as Ar, R₁, R₂, X, y and n, respectively, in Formulas (III) or (IV) and (V).

18. The method according to claim 17 wherein the aralkyl halide according to the formula (III) is: 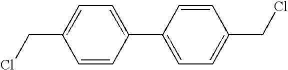
and the trialkyl phosphite is selected from the group consisting of trimethyl phosphite, triethyl phosphite, tripropyl phosphite, tributyl phosphite and combinations of the foregoing.

19. The method according to claim 18 wherein the trialkyl phosphite is triethyl phosphite.

20. The method according to claim 19 wherein the aralkyl dialkyl phosphonate in the bottoms product is 4,4′ (bis-methyl diethyl phosphonate) biphenyl.

21. The method according to claim 20 wherein the 4,4′ (bis-methyl diethyl phosphonate) biphenyl is washed with an organic solvent and collected as a solid via filtration.
